(19) United States
(12) Patent Application Publication
(10) Pub. No.: US 2014/0028619 A1
(43) Pub. Date: Jan. 30, 2014

(54) Touch Sensitive Apparatus, Mobile Terminal And Terminal Device

(71) Applicant: Lenovo (Beijing) Co., Ltd., Beijing (CN)

(72) Inventors: Longhai Huang, Beijing (CN); Haifeng Yu, Beijing (CN); Jin Liu, Beijing (CN); Ke Shang, Beijing (CN)

(73) Assignee: Lenovo (Beijing) Co., Ltd., Beijing (CN)

(21) Appl. No.: 13/954,222

(22) Filed: Jul. 30, 2013

(30) Foreign Application Priority Data
Jul. 30, 2012 (CN) CN 201210268889.2
Nov. 27, 2012 (CN) CN201210492419.4

(51) Int. Cl. H04B 1/38; G06F 3/041

(52) U.S. Cl. CPC H04B 1/3827; G06F 3/0412
USPC 345/174; 455/575.1

(57) ABSTRACT

A touch sensitive apparatus, a mobile terminal and a terminal device are described. The touch sensitive apparatus includes a main body of the touch sensitive apparatus and an antenna built inside of the main body.

This application claims priority to Chinese patent application No. 201210268889.2 filed on Jul. 30, 2012, and also to Chinese patent application No. 201210492419.4 filed on Nov. 27, 2012, the entire contents of which are incorporated herein by reference.

### BACKGROUND

The present disclosure relates to a touch sensitive apparatus, a mobile terminal and a terminal device.

A mobile terminal refers to a computer device that is movable in use, and may broadly comprise a cell phone, a laptop, a tablet, or even a POS terminal, a vehicle-mounted computer or a portable medical device, and so on. In most cases, the mobile terminal mainly refers to a cell phone, or alternatively a smart phone or a tablet with various applications.

In the prior art, the mobile terminal has a very powerful capability, and is equivalent to a contact ultra-small computer system, which can not only communicate, photograph, play music, play game, but can also realize many functions comprising locating, information processing, network application, fingerprint scanning, barcode scanning, RFID scanning, IC card scanning, etc. The mobile terminal has become an important tool in the mobile work and mobile business environment. The mobile terminal can communicate in many ways. For example, it may communicate by a wireless mobile operator network such as GSM, CDMA, WCDMA, EDGE, 3G etc., or by a wireless local network, the Bluetooth and the infrared ray, etc. With the popularization of the mobile terminal, the market competence has become more and more keen. The appearance, the touch feel and the communication quality of the mobile terminal are important to the user choice, on the basis of meeting the requirement for functions. The application of a touch screen and a complete metal back cover, and the design of an ultra-thin body have become a fashion element in the current design for the mobile terminal. Meanwhile, it brings a huge challenge to the antenna design for the mobile terminal.

Taking the cell phone as an example, it is well known that currently most cell phones adopt built-in antennas, wherein the PIFA antenna and the single polar antenna are the main kinds of the built-in antenna. FIG. 1 shows a schematic layout diagram of the typical PIFA antenna on a cell phone. As shown in FIG. 1, the touch screen 3 and the back cover 1 combine to form the casing of the cell phone, the main board 2 is arranged in the casing, and the PIFA antenna 4 is arranged on the main board 2. Since the height of the PIFA antenna is required to be no less than 6.5 mm, the total thickness H1 of the cell phone is limited. Also, for the cell phone with a back cover completely made of metal, the performance of the built-in antenna is easily influenced by the metal back cover, which results in a severe deterioration of the antenna performance. Therefore, a process for removing the metal of a part of the metal back cover is necessary. This process sacrifices the appearance and the touch feel of the product while meeting the requirement for antenna performance. The other design schemes for the antenna based on micro-band feed and gap radiation principle also have the above drawbacks and disadvantages.

It can be seen that the current design for the built-in antenna of the mobile terminal makes the touch feel (the metal feel and the ultra-thin feel) of the mobile terminal bad, and the structure strength of the ultra-thin cell phone is also greatly influenced.

Therefore, the current built-in antenna of the mobile terminal needs to be optimized, to decrease the thickness of the body of the ultra-thin terminal whiling improving the antenna performance of the mobile terminal, thereby meeting the customer's requirements.

### SUMMARY

In view of the above, the embodiments of the disclosure provide a touch sensitive apparatus, a mobile terminal and a terminal device, which can decrease the thickness of the mobile terminal, improve the antenna performance of the mobile terminal, and meet the customer's requirements.

According to an aspect of the present disclosure, a touch sensitive apparatus of a mobile terminal is provided, comprising: a main body of the touch sensitive apparatus; and an antenna built inside of the main body.

In the touch sensitive apparatus, the feed line of the antenna is integrated in a row line of the main body.

In the touch sensitive apparatus, the antenna is a sheet of metal, and is embedded in the main body.

In the touch sensitive apparatus, the antenna is made of conductive material, and is printed in the main body.

In the touch sensitive apparatus, the antenna comprises at least one main communication antenna for communication through mobile communication operator network, and the main communication antenna is arranged in a lower part of the touch sensitive area of the main body.

In the touch sensitive apparatus, the main body comprises: a touch sensitive panel having a first region; a scan electrode arranged on a second region of the touch sensitive panel, the second region is within the first region, and the area of the second region is smaller than that of the first region; a scan line connected to the scan electrode; a drive electrode arranged on the second region of the touch sensitive panel intersected with the scan electrodes; and a drive line connected to the drive electrode; and wherein, the antenna is arranged on a third region not overlapping with the second region, of the touch sensitive panel.

In the touch sensitive apparatus, the antenna is constructed of a thin film made of a metal or semiconductor material.

In the touch sensitive apparatus, the combination of the third region and the second region forms the first region.

In the touch sensitive apparatus, the scan line and the drive line are arranged in the third region; the antenna in the third region is not overlapped with the region where the scan line and the drive line locate.

According to another aspect of the disclosure, a mobile terminal is provided, comprising a casing formed of a touch sensitive apparatus and a back cover, a main board is arranged in the casing, and the touch sensitive apparatus is the above described touch sensitive apparatus.

In the mobile terminal, the back cover is made of metal, and has no hollow carved.

According to another aspect of the disclosure, a terminal device is provided, comprising: a display screen; and a touch sensitive apparatus comprising: a touch sensitive panel having a first region, arranged on the display screen; a scan electrode arranged on a second region of the touch sensitive panel, the second region is within the first region, the area of the second region is smaller than that of the first region, and the second region corresponds to the display region of the display screen; a scan line connected to the scan electrode; a drive electrode arranged on the second region of the touch sensitive panel intersected with multiple scan electrodes; a drive line connected to the drive electrode; and a first antenna arranged on a third region not overlapping with the second region, of the touch sensitive panel.

### BRIEF DESCRIPTION OF THE DRAWINGS

FIG. 1 is a layout diagram of a typical built-in antenna of a cell phone in the prior art;

FIG. 2 is a schematic diagram of a touch screen of a mobile terminal according to a first embodiment of the disclosure;

FIG. 3 is a schematic diagram of a touch screen of a mobile terminal according to a second embodiment of the disclosure;

FIG. 4 is a schematic diagram of a touch screen of a mobile terminal according to a third embodiment of the disclosure;

FIG. 5 is a sectional schematic diagram of the mobile terminal according to an embodiment of the disclosure;

FIG. 6 is a schematic diagram showing a touch sensitive apparatus according to an exemplary embodiment of the disclosure; and

FIG. 7 is a schematic diagram showing a terminal device according to an exemplary embodiment of the disclosure.

### DETAILED DESCRIPTION

Hereinafter the embodiments of the disclosure will be described with reference to the accompany drawings. It is noted that like reference number is used to represent that with like step and element and the repeated explanation for them will be omitted. Here, the touch sensitive apparatus according to the embodiment of the present disclosure may be a touch sensitive apparatus such as a capacitive touch panel etc., and the touch sensitive apparatus according to the embodiment of the present disclosure may be applied to a terminal device such as a smart phone, a tablet etc.

The core of the present disclosure is to provide a touch sensitive apparatus (referred to as a touch screen hereinafter when appropriate) of a mobile terminal, which integrates the antenna inside of the touch screen, and utilizes the touch screen as the bearer of the antenna. The solution may effectively decrease the thickness of the mobile terminal on one hand, and may improve the performance of the antenna on the other hand. In the following, the embodiments of the present disclosure will be described in further detail with reference to the figures for being better understood by those skilled in the art.

Without losing generality, the cell phone will be described as an example in the following. In the description, the terms indicative of location such as “up” or “down” are defined on the basis of the condition that the part corresponding to the headphone of the cell phone is up and the part corresponding to the speak phone of the cell phone is down. It should be understood that such application of the terms does not limit the protection scope of the present application.

### Embodiment 1

Referring to FIG. 2, FIG. 2 is a schematic diagram of a touch screen of a mobile terminal according to an embodiment of the present disclosure.

As shown in FIG. 2, the touch screen comprises a main body 11 of the touch screen and an antenna 13 built inside of the main body 11. The antenna 13 is a planar antenna and may be realized in two ways. In the first way, the antenna is made of a sheet metal, and the antenna is embedded in the main body 11. In the second way, a conductive material is printed in the main body 11 to form the antenna. The feed line of the antenna 13 may be connected to the main board of the mobile terminal by being integrated into the row line of the main body. With this arrangement, the welding of the feed line to the corresponding welding point on the main board is not necessary, it is easy for the assembling of the touch screen and the antenna, and the production efficiency is improved.

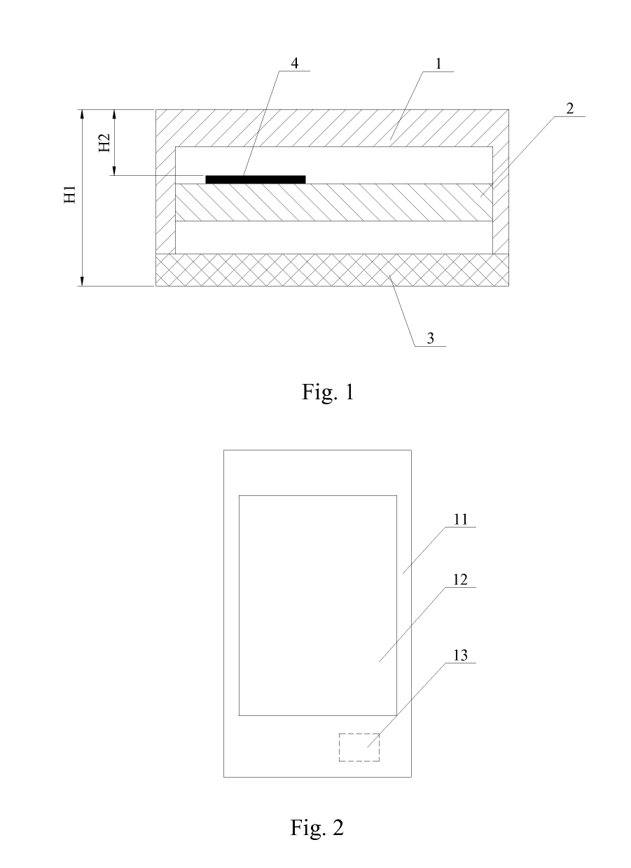

Also referring to FIG. 5, it shows a sectional schematic diagram of the mobile terminal with the above touch screen. The reference numerals of the components in FIG. 5 are the same to those in FIG. 1, to clearly show the identical part and the difference between them. As shown in FIG. 5, the mobile terminal has a basically similar construction to that in FIG. 1, and the difference lies in that the antenna is arranged at a different position. Since the antenna 4 is arranged in the touch screen 3, the height H2 of the antenna is increased, and thereby the thickness H1 of the terminal is decreased.

In the present embodiment, the antenna 13 is the main communication antenna for communication through the mobile communication operator network. For example, the antenna 13 may cover different bands by changing its shape, so as to match with the wireless mobile operator networks such as GSM, CDMA, WCDMA, EDGE or 3G. The technology about the design for the main communication antenna to meet the corresponding requirements of the wireless mobile operator network is known to those skilled in the art, and will not described here to avoid redundancy.

It is well known that the cell phone transfers information by receiving and transmitting electromagnetic wave. When the cell phone is used, it transmits wireless electrical waves to the base station and may influence the health of people.

To decrease the influence to the human brain, in the present embodiment, the antenna 13 as the main communication antenna is arranged at the lower part of the touch sensitive area 12 of the main body 11. With this arrangement, the influence to the antenna performance by the electrical elements in the touch sensitive area 12 and the LCD is decreased on one hand, and the influence to the brain by the antenna irradiation is decreased on the other hand, since the distance from the antenna to the head of the user is larger, thereby it is advantageous to the user health.

### Embodiment 2

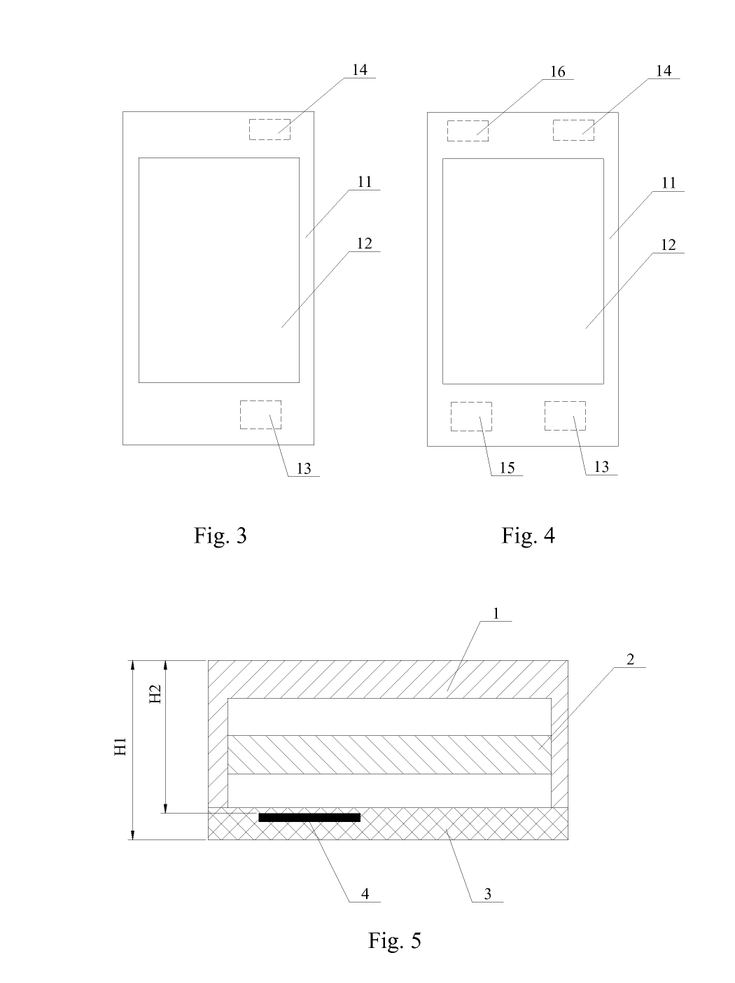

Referring to FIG. 3, it is a schematic diagram of a touch screen of a mobile terminal of the second embodiment.

As shown in FIG. 3, on the basis of the touch screen of the first embodiment, a secondary communication antenna 14 is added in the present embodiment, which is used for the wireless application, such as: the WiFi antenna, the BT (Bluetooth) antenna or the NFC antenna for wireless communication in a near distance; a FM antenna for receiving a radio broadcasting signal; a GPS antenna for global location, etc.

In the present embodiment, the secondary communication antenna 14 is any one of the above antennas.

### Embodiment 3

Referring to FIG. 4, it is a schematic diagram of a touch screen of a mobile terminal of the third embodiment.

As shown in FIG. 4, on the basis of the mobile terminal according to the second embodiment, a main communication antenna 15 and a secondary communication antenna 16 are respectively added in the present embodiment. In the present embodiment, the touch screen has two main communication antennas 13, 15 and two secondary communication antennas 14, 16. The first and the second main communication antennas 13 and 15 match with different mobile communication operator networks, respectively. For example, the first main communication antenna 13 matches with the GSM mobile communication network, and the second main communication antenna 15 matches with the CDMA mobile communication network. In this way, the touch screen may be applied to a dual mode cell phone. The first and the second secondary communication antennas 14 and 16 match with different wireless applications, respectively. For example, the first secondary communication antenna 14 realizes the WiFi function, and the second secondary communication antenna 16 realizes the GPS location function.

The above three embodiments are only for exemplary description of the present disclosure. Those skilled in the art may further improve the solution on the basis of the above embodiments, especially on the basis of the third embodiment.

For example, according to the third embodiment, the two main communication antennas 13 and 15 may match with the GSM and the WCDMA mobile communication networks, or the EDGE and the CDMA mobile communication networks, respectively. In summary, different mobile communication operator networks may be matched by changing the shape of the main communication antenna.

Similarly, the first and the second secondary communication antennas 14 and 16 may realize the WiFi and the Bluetooth functions, or the GPS location and the NFC functions, respectively. Of course, the number of the secondary communication antennas is not limited to two, and more than two secondary communication antennas may be arranged to realize the combination of multiple wireless applications, for example, the combination of WiFi, Bluetooth and GPS functions; the combination of WiFi, FM and NFC functions; the combination of WiFi, Bluetooth, GPS and NFC functions; the combination of WiFi, Bluetooth, FM, GPS and NFC functions; and so on. Those skilled in the art may select from the above combinations of various functions according to the particular application of the mobile terminal.

In summary, in the touch screen of the mobile terminal according to the present disclosure, since the antenna is arranged in the touch screen and the touch screen is used as the bearer of the antenna, the touch screen has multiple functions, and the antenna is minimized with a lower cost. The antenna design for an ultra-thin completely-metal mobile terminal is realized, and the thickness limit problem and the antenna design problem in the ultra-thin completely-metal mobile terminal are effectively solved.

In addition, a mobile terminal is provided in the present disclosure, as shown in FIG. 5, comprising a casing formed of a touch screen 3 and a back cover 1. A main board 2 is arranged in the casing. The touch screen 3 is any one of the above touch screens. Therefore, the thickness of the whole mobile terminal is effectively decreased. The thickness of the current ultra-thin cell phone is about 6.5 mm. In the embodiment of the present disclosure, the ultra-thin metal cell phone may be of a thickness of 5 mm in practice.

It should be noted that the mobile terminal in the present disclosure may be, but not limited to, the cell phone, the tablet, the portable medical device, or the POS terminal.

In the above solution, the back cover of the mobile terminal is made of metal with no hollow carved. The all metal back cover makes the appearance of the mobile terminal very cool and improves the intensity of the terminal.

Also, the all-metal back cover may be used as the ground of the antenna, makes the bad influence of the all-metal back cover to be good to the antenna performance. The mobile terminal will have a good antenna radiation efficiency and performance, and the overall thickness of the mobile terminal is further decreased. Of course, according to the design requirement of the antenna of the cell phone, the horizontal distance between the main communication antenna and the lower side of the main board should be larger than or equal to 5 mm, in order to improve the performance of the main communication antenna.

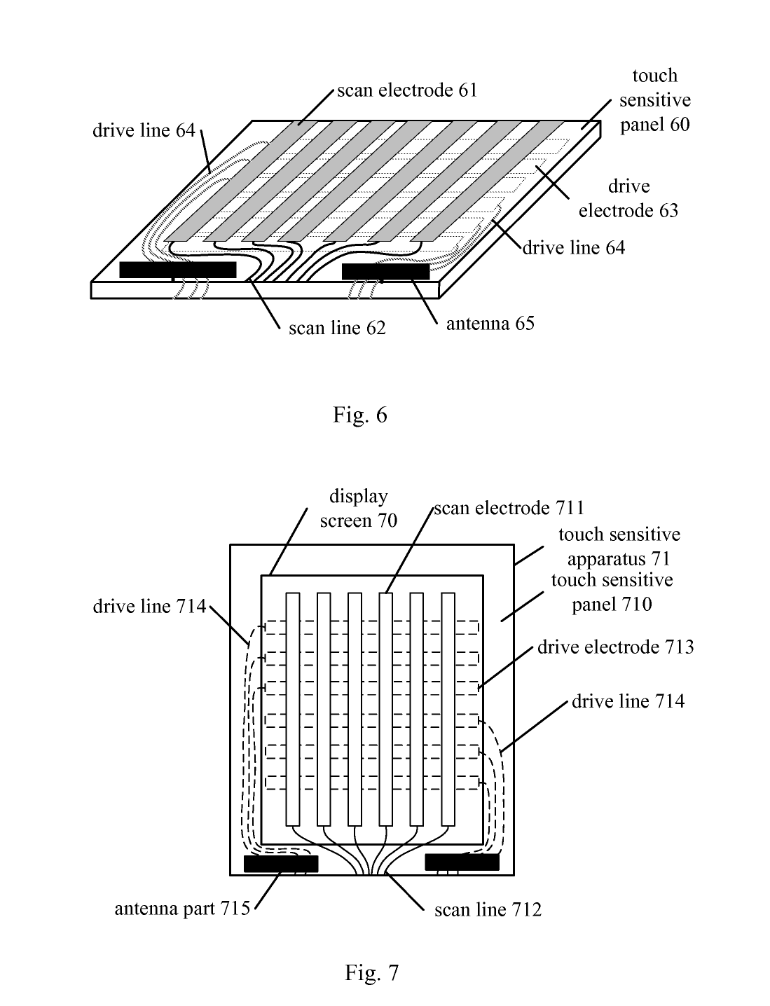

The touch sensitive apparatus according to an embodiment of the present disclosure will be described in the following with reference to FIG. 6. FIG. 6 is a schematic diagram showing the touch sensitive apparatus according to an exemplary embodiment of the present disclosure.

As shown in FIG. 6, the touch sensitive apparatus according to the embodiment of the present disclosure may comprise a touch sensitive panel 60, a scan electrode 61, a scan line 62, a drive electrode 63, a drive line 64 and an antenna 65.

Here, the touch sensitive panel 60 of the touch sensitive apparatus may be formed of a thin plate made of any glass or plastic material. The touch sensitive panel 60 may have a preset size. Here, the touch sensitive panel 60 is larger than the display area of the display screen of the terminal device to which it is applied. Here, the whole region of the upper surface (towards to the outside of the display screen) of the touch sensitive panel 60 is referred to as the first region.

The scan electrode 61 may be formed of a metal or a semiconductor material (such as the silver, the copper, the ITO etc.). Multiple scan electrodes 61 may be arranged in a specific direction (such as horizontally or vertically) of the touch sensitive region (referred to as the second region hereinafter) of the touch sensitive panel 60, by etching. Here, the scan electrode 61 may be arranged in the second region of a specific layer of the touch sensitive panel 60. In this case, the second region is in the range of the first region (the whole region) of the touch sensitive panel 60, normally in the central region of the first region. The area of the second region is smaller than that of the first region.

The scan line 62 is connected to the scan electrode 61, and may transmit the scan signal generated by the scan electrode to the controller (not shown) of the touch sensitive panel 60. Here, the scan line 62 may be arranged in the same layer as the scan electrode 61 to be connected to the scan electrode.

The drive electrode 63 may be formed of metal or semiconductor material such as the silver, the copper, the ITO etc. The drive electrode 63 may also be arranged in the touch sensitive region (the second region) of the touch sensitive panel 60. For example, multiple drive electrodes 63 may be arranged in the touch sensitive region of the touch sensitive panel 60 in a specific direction (such as, horizontally or vertically). Here, it is to be noted that the drive electrode 63 may be arranged in a different layer from the scan electrode 61. For example, the drive electrode 63 may be arranged in a layer lower or upper than the scan electrode 61, and intersect with the scan electrode 61. For example, when the multiple scan electrodes 61 are arranged horizontally in the touch sensitive panel 60, the drive electrode 63 may be arranged vertically in the touch sensitive panel 60, or vice versa. In this case, the scan electrode 61 and the drive electrode intersected in the second region may form the touch sensitive array of the touch sensitive panel 60.

The drive line 64 is connected to the drive electrode 63, and may transmit the drive signal generated by the driver (not shown) of the touch sensitive panel 60 to the drive electrode 63. Here, since the structures and the functions of the scan electrode 61, the scan line 62, the drive electrode 63 and the drive line 64 of the touch sensitive panel 60 are known to those skilled in the art, the detailed descriptions are omitted here.

The antenna 65 may be arranged in the touch sensitive panel 60. Here, according to an embodiment of the present disclosure, the antenna 65 may be arranged in a region (hereinafter referred to as the third region) separate from the second region where the scan electrode 61 and the drive electrode 63 locate. That is, the third region where the antenna 65 is arranged does not overlap with the second region where the scan electrode 61 and the drive electrode 63 are arranged, and the third region and the second region may form the first region of the touch sensitive panel 60. For example, when the second region is the central region of the touch sensitive panel 60, the third region may be the peripheral region of the touch sensitive panel 60. That is, when the touch sensitive panel 60 is used as the touch sensitive panel of the touch screen of the terminal device such as the small phone or the tablet, the second region may correspond to the display region (the central region) of the touch screen of the terminal device, and the third region may correspond to the frame region of the touch screen of the terminal device.

According to an embodiment of the present disclosure, the antenna 65 may be arranged in the third region of the touch sensitive panel 60 by etching. For example, the antenna 65 may be formed by etching the metal material such as the copper, the silver, etc., or the semiconductor material on the predetermined layer of the third region of the touch sensitive panel 60, so that the metal material or the semiconductor material forms a thin film capable of transmitting/receiving the RF signal. In this case, the thin film made of the metal material or the semiconductor material may be used as the antenna 65. Here, since the touch sensitive panel 60 is usually used as the touch sensitive panel of the touch screen of the terminal device such as the smart phone or the tablet, and this kind of terminal devices usually has a relatively large size, the third region as the frame region of the touch sensitive panel 60 usually has a relatively long length and width (for example, with a length above 100 mm, and a width above 50 mm). In this case, since the length of the current antenna for receiving the 2G/3G/4G, WiFi or the Bluetooth signal usually may be shorter than 10 mm, the third region of the touch sensitive panel 60 is sufficient to arrange enough long metal or semiconductor thin film to function as the antenna 65 for receiving the RF signal such as the 2G/3G/4G, WiFi, the Bluetooth signal etc. Here, since the third region as the frame region has a length and a width long enough, the location of the antenna 65 is not limited, as long as the length of the arranged (etched) antenna 65 (metal or semiconductor thin film) is sufficient to receive the RF signal such as the 2G/3G/4G, WiFi, the Bluetooth signal etc.

Also, since the scan line 62 needs to be connected to the controller of the touch sensitive panel 60, and multiple scan lines 62 need to be arranged corresponding to the scan electrodes 6I of multiple rows, also since the drive line 64 needs to be connected to the driver of the touch sensitive panel 60, and multiple drive lines 64 need to be arranged corresponding to the drive electrodes 63 of multiple rows, as shown in FIG. 6, the scan line 62 and the drive line 64 require to occupy a part of the third region. Here, to avoid the scan signal of the scan line 62 and the drive signal of the drive line 64 from being affected by the RF signal received/transmitted by the antenna 65, the location of the antenna 65 in the third region may not be overlapped with the region where the scan line 62 and the drive line 64 locate.

For example, as shown in FIG. 6, assuming that the scan electrode 61 is arranged in the layer upper than the drive electrode 63, and is arranged vertically on the touch sensitive panel 60, while the drive electrode 63 is arranged horizontally on the touch sensitive panel 60. In this case, as shown in FIG. 6, the antenna 65 may be arranged at two sides of the scan line 62. Here, the antenna 65 does not contact with the scan line 62, and since the antenna 65 and the drive line 64 are in different layers, they do not contact with each other. Therefore, it ensures that the scan signal of the scan line 62 and the drive signal of the drive line 64 are not affected. Also, the present disclosure is not limited to the case shown in FIG. 6. For example, the antenna 65 may be arranged at two sides of the array of the scan electrode 61. In this case, the antenna 65 does not contact with the scan line 62, and since the antenna 65 and the drive line 64 are in different layers, they do not contact with each other. Also, as long as the antenna 65 in the third region does not contact with the scan line 62 and the drive line 64, it may be arranged in other positions of the third region.

With the above configuration, the antenna 65 may be arranged in a region (such as the frame region) of the touch sensitive panel 60 where no electrode (either the scan electrode or the drive electrode) locates. In this case, without affecting the touch function of the touch sensitive panel 60, since the antenna 65 is arranged outside, the RF signal may be transmitted/received without being affected by the casing of the terminal device to which it is applied, so as to achieve a better signal transmitting/receiving effect. Also, the design of the antenna 65 may be greatly simplified by arranging the antenna 65 in the third region of the touch sensitive panel 60.

In the following, the terminal device according to an embodiment of the disclosure will be described with reference to FIG. 7. Here, the terminal device according to the embodiment of the disclosure may be the terminal device such as the smart phone or the tablet. As shown in FIG. 7, the terminal device according to the embodiment of the disclosure may comprise the display screen 70 and the touch sensitive apparatus 71.

Here, similar to those in FIG. 6, the touch sensitive apparatus 71 may comprise a touch sensitive panel 710, a scan electrode 711, a scan line 712, a drive electrode 713, a drive line 714 and an antenna part 715.

Here, since the touch sensitive panel 710, the scan electrode 711, the scan line 712, the drive electrode 713, the drive line 714 and the antenna part 715 are the same as or similar to the touch sensitive panel 60, the scan electrode 61, the scan line 62, the drive electrode 63, the drive line 64 and the antenna 65 of FIG. 6, respectively, they will be described briefly.

The touch sensitive panel 710 of the touch sensitive apparatus may be formed of a thin plate made of any glass or plastic material, and the area of the touch sensitive panel 710 is larger than the display area of the display screen 70. Here, the whole region of the upper surface of the touch sensitive panel 710 is referred to as the first region.

The scan electrodes 711 may be arranged in a specific direction (such as horizontally or vertically) of the touch sensitive region (referred to as the second region hereinafter) of the touch sensitive panel 710, by etching. For example, the scan electrode 711 may be arranged in the second region of a specific layer of the touch sensitive panel 710. The second region is in the range of the first region (the whole region) of the touch sensitive panel 710. The area of the second region is smaller than that of the first region. The second region normally corresponds to the display region of the display screen 70. The scan line 712 is connected to the scan electrode 711, and may be arranged in the same layer as the scan electrode 711 to be connected to the scan electrode.

The drive electrode 713 may also be arranged in the second region of the touch sensitive panel 710 in a specific direction (such as, horizontally or vertically) by etching. Here, the drive electrode 713 may be arranged in a different layer from the scan electrode 711, and intersect with the scan electrode 711. Here, the scan electrode 711 and the drive electrode intersected in the second region may form the touch sensitive array of the touch sensitive panel 710. The drive line 714 is connected to the drive electrode 713, and may be in the same layer as the drive electrode 713.

The antenna 715 may be arranged in the touch sensitive panel 710. For example, the antenna 715 may be arranged in a region (hereinafter referred to as the third region) separate from the second region where the scan electrode 711 and the drive electrode 713 locate. That is, the third region does not overlap with the second region. Here, the third region and the second region may form the first region of the touch sensitive panel 710. For example, when the second region corresponds to the display region of the display screen 70, the third region may correspond to the peripheral (frame) region of the touch sensitive panel 710. Particularly, the antenna 715 may be formed by etching the metal material such as the copper, the silver, etc., or the semiconductor material on the predetermined layer of the third region of the touch sensitive panel 710, so that the metal material or the semiconductor material forms a thin film capable of transmitting/receiving the RF signal. Here, since the touch sensitive panel 710 is usually used as the touch sensitive panel of the touch screen of the terminal device, and this kind of terminal devices usually has a relatively large size, the third region of the touch sensitive panel 710 usually has a relatively long length and width (for example, with a length above 100 mm, and a width above 50 mm). In this case, since the length of the current antenna for receiving the 2G/3G/4G, WiFi or the Bluetooth signal usually may be shorter than 10 mm, the third region of the touch sensitive panel 710 is sufficient to arrange enough long metal or semiconductor thin film to function as the antenna 715 for receiving the RF signal such as the 2G/3G/4G, WiFi, the Bluetooth signal etc. Here, since the third region as the frame region has a length and a width long enough, the particular location of the antenna 715 is not limited.

Also, similar to those in FIG. 6, due to layout design, the scan line 712 and the drive line 714 require to occupy a part of the third region. Here, to avoid the scan signal of the scan line 712 and the drive signal of the drive line 714 from being affected by the RF signal received/transmitted by the antenna 715, the location of the antenna 715 in the third region may be not overlapped with the region where the scan line 712 and the drive line 714 locate. For example, assuming that the scan electrode 711 is arranged in the layer upper than the drive electrode 713, and is arranged vertically on the touch sensitive panel 710, while the drive electrode 713 is arranged horizontally on the touch sensitive panel 710. In this case, the locations of the scan line 712 and the drive line 714 may be as shown in FIG. 7. In this case, the antenna 715 may be arranged at two sides of the scan line 712 as shown in FIG. 7. Here, the antenna 715 does not contact with the scan line 712, and since the antenna 715 and the drive line 714 are in different layers, they do not contact with each other. Therefore, it ensures that the scan signal of the scan line 712 and the drive signal of the drive line 714 are not affected. Also, the present disclosure is not limited to the case shown in FIG. 7. For example, the antenna 715 may be arranged at two sides of the array of the scan electrode 711. In this case, the antenna 715 does not contact with the scan line 712, and since the antenna 715 and the drive line 714 are in different layers, they do not contact with each other. Also, as long as the antenna 715 in the third region does not contact with the scan line 712 and the drive line 714, it may be arranged in other positions in the third region.

Also, the terminal device may comprise a Radio Frequency (RF) module (not shown). The RF module may be arranged inside of the terminal device. Here, the RF module is electrically coupled to the antenna 715. In this case, the RF signal from the RF module may be transmitted through the antenna 715, and the RF signal received by the antenna 715 may be transmitted to the RF module, so that the terminal device may realize the 2G/3G/4G, WiFi or the Bluetooth function.

With the above configuration, the antenna 715 may be arranged in a region (such as the frame region) of the touch sensitive panel 710 where no electrode (either the scan electrode or the drive electrode) locates. In this case, without affecting the touch function of the touch sensitive panel 710, since the antenna 715 is arranged outside of the terminal device, the RF signal may be transmitted/received without being affected by the casing of the terminal device to which it is applied, so as to achieve a better signal transmitting/receiving effect. Also, the design of the antenna 715 may be greatly simplified by arranging the antenna 715 in the third region of the touch sensitive panel 710.

According to one aspect of the present disclosure, a touch sensitive apparatus of a mobile terminal is provided, wherein the touch sensitive apparatus comprises a main body of the touch sensitive apparatus and an antenna, and the antenna is built in side of the main body.

Optionally, the feed line of the antenna is integrated in the row line of the main body.

Optionally, the antenna is a sheet of metal, and is embedded in the main body.

Optionally, the antenna is made of conductive material, and is printed in the main body.

Optionally, the antenna comprises at least one main communication antenna for communication through the mobile communication operator network, and the main communication antenna is arranged in the lower part of the touch sensitive area of the main body.

Optionally, the antenna comprises two main communication antennas for matching with different mobile communication operator networks.

Optionally, the antenna is an IFA antenna, a PIFA antenna, a LOOP antenna or a single polar antenna.

Optionally, the antenna further comprise at least one secondary communication antenna for wireless application, and the secondary communication antenna is arranged in the upper part or the edge of the touch sensitive area of the main body.

Optionally, the secondary communication antenna is a combination of any one, two or more than two of the GPS, BT, WiFi, FM or NFC antenna.

According to another aspect of the present disclosure, a mobile terminal is provided comprising a casing formed of a touch screen and a back cover, a main board is arranged in the casing, and the touch screen is any one of the above touch sensitive apparatus.

Optionally, the back cover is made of metal, and has no hollow carved.

Optionally, the horizontal distance from the main communication antenna to the lower side of the main board is larger than or equal to 5 mm.

Optionally, the mobile terminal is a cell phone.

Optionally, the mobile terminal is a tablet.

Optionally, the mobile terminal is a portable medical device or a POS terminal.

The antenna is arranged in the touch sensitive apparatus, according to the touch sensitive apparatus of the terminal device provided by the present disclosure, and the touch sensitive apparatus is used as the bearer of the antenna. In this way, the thickness of the mobile terminal with this touch sensitive apparatus is decreased, and a new idea of the design for the ultra-thin mobile terminal is provided, thereby the antenna irradiation to the human being is effectively controlled while ensuring the antenna performance of the mobile terminal.

In an alternative embodiment of the present disclosure, the feed line of the antenna is integrated in the row line of the main body. With this arrangement, when the mobile terminal is assembled, the assembling of the touch sensitive apparatus and the antenna may be done simultaneously by inserting the row line of the touch sensitive apparatus into the corresponding socket. No welding is necessary, the assembling process for the touch sensitive apparatus and the antenna is improved, and the product efficiency is increased.

In another alternative embodiment of the present disclosure, the antenna comprises at least one main communication antenna for communication through the mobile communication operator network, thereby a solution for a dual mode mobile terminal is provided. Also, the main communication antenna is arranged in the lower part of the touch sensitive area of the main body. In this way, the influence to the antenna by the main body and the electrical elements on the LCD is effectively decreased, and the influence to the human body by the antenna irradiation is decreased.

In a further alternative embodiment of the present disclosure, the antenna further comprise at least one secondary communication antenna for wireless application, and the secondary communication antenna is arranged in the upper part or the edge of the touch sensitive area of the main body. With this arrangement, the mobile terminal can further realize the functions such as the locating, the information processing, the network application, the fingerprint scanning, the barcode scanning, the RFID scanning, the IC card scanning etc., in addition to the mobile communication, so that the mobile terminal becomes an important tool in the mobile law-execution, the mobile work and the mobile business environments.

According to another aspect of the present disclosure, a touch sensitive apparatus is provided, comprising: a touch sensitive panel having a first region; a scan electrode arranged on a second region of the touch sensitive panel, the second region is within the first region, and the area of the second region is smaller than that of the first region; a scan line connected to the scan electrode; a drive electrode arranged on the second region of the touch sensitive panel intersected with the multiple scan electrodes; a drive line connected to the drive electrode; and a first antenna arranged on a third region not overlapping with the second region, of the touch sensitive panel.

Also, according to an embodiment of the present disclosure, the first antenna is constructed of a thin film made of a metal or semiconductor material.

Also, according to an embodiment of the present disclosure, the combination of the third region and the second region forms the first region.

Also, according to an embodiment of the present disclosure, the scan line and the drive line are arranged in the third region; the first antenna in the third region is not overlapped with the region where the scan line and the drive line locate.

Also, according to another aspect of the present disclosure, a terminal device is provided, comprising: a display screen; and a touch sensitive apparatus comprising: a touch sensitive panel having a first region, which is arranged on the display screen; a scan electrode arranged on a second region of the touch sensitive panel, the second region is within the first region, and the area of the second region is smaller than that of the first region, and the second region corresponds to the display region of the display screen; a scan line connected to the scan electrode; a drive electrode arranged on the second region of the touch sensitive panel intersected with the multiple scan electrodes; a drive line connected to the drive electrode; and a first antenna arranged on a third region not overlapping with the second region, of the touch sensitive panel.

Also, according to an embodiment of the present disclosure, the first antenna is constructed of a thin film made of a metal or semiconductor material.

Also, according to an embodiment of the present disclosure, the combination of the third region and the second region forms the first region.

Also, according to an embodiment of the present disclosure, the scan line and the drive line are arranged in the third region; the first antenna in the third region is not overlapped with the region where the scan line and the drive line locate.

Also, according to an embodiment of the present disclosure, the terminal device further comprises a RF module arranged in side of the terminal device; the RF module is electrically coupled to the first antenna, and transmits/receives an RF signal through the first antenna.

The individual embodiments of the present disclosure have been disclosed above in detail. However, those skilled in the art should understand that various modifications, combinations, partial combinations and alternations may be made to the disclosure depending on the design requirement and other factors, as long as they are within the scope of the appended claims and their equivalents.

1. A touch sensitive apparatus of a mobile terminal, comprising:
a main body of the touch sensitive apparatus; and
an antenna built inside of the main body.

2. The touch sensitive apparatus of claim 1, wherein a feed line of the antenna is integrated in a row line of the main body.

3. The touch sensitive apparatus of claim 1, wherein the antenna is a sheet of metal, and is embedded in the main body.

4. The touch sensitive apparatus of claim 1, wherein the antenna is made of a conductive material which is printed in the main body.

5. The touch sensitive apparatus of claim 1, wherein the antenna comprises at least one main communication antenna for communication through mobile communication operator network, and the main communication antenna is arranged in a lower part of a touch sensitive area of the main body.

6. The touch sensitive apparatus of claim 1, wherein the main body comprises:
a touch sensitive panel having a first region;
a scan electrode arranged on a second region of the touch sensitive panel, the second region is within the first region, and the area of the second region is smaller than that of the first region;
a scan line connected to the scan electrode;
a drive electrode arranged on the second region of the touch sensitive panel intersected with the scan electrode; and
a drive line connected to the drive electrode;
and wherein, the antenna is arranged on a third region not overlapping with the second region, of the touch sensitive panel.

7. The touch sensitive apparatus of claim 6, wherein the antenna is constructed of a thin film made of a metal or semiconductor material.

8. The touch sensitive apparatus of claim 6, wherein the combination of the third region and the second region forms the first region.

9. The touch sensitive apparatus of claim 6, wherein, the scan line and the drive line are arranged in the third region; and the antenna in the third region is not overlapped with the region where the scan line and the drive line locate.

10. A mobile terminal comprising a casing formed of a touch sensitive apparatus and a back cover, wherein a main board is arranged in the casing, and the touch sensitive apparatus includes a main body and an antenna built inside of the main body.

11. The mobile terminal of claim 10, wherein the back cover is made of metal and has no hollow carved.

12. A terminal device, comprising:
a display screen; and
a touch sensitive apparatus comprising:
a touch sensitive panel having a first region, which is arranged on the display screen;
a scan electrode arranged on a second region of the touch sensitive panel, wherein, the second region is within the first region, the area of the second region is smaller than that of the first region, and the second region corresponds to a display region of the display screen;
a scan line connected to the scan electrode;
a drive electrode arranged on the second region of the touch sensitive panel intersected with the scan electrodes;
a drive line connected to the drive electrode; and
an antenna arranged on a third region not overlapping with the second region, of the touch sensitive panel.
